(19) United States
(12) Patent Application Publication
(10) Pub. No.: US 2013/0130185 A1
(43) Pub. Date: May 23, 2013

(54) METHOD FOR STARTING A SINTERING FURNACE, AND SINTERING EQUIPMENT

(71) Applicant: Tuomas Herlevi, Espoo (FI)

(72) Inventor: Tuomas Herlevi, Espoo (FI)

(73) Assignee: OUTOTEC OYJ, Espoo (FI)

(21) Appl. No.: 13/813,617

(22) PCT Filed: Sep. 22, 2011
(86) PCT No.: PCT/FI2011/050816

§ 371 Date: Jan. 31, 2013

(30) Foreign Application Priority Data
Sep. 24, 2010 (FI) 20105986

(51) Int. Cl. F27D 9/00

(52) U.S. Cl. CPC F27D 9/00
USPC 432/12; 432/77; 432/32

(57) ABSTRACT

The invention relates to a method and equipment for starting up a strand sintering furnace (1). During start-up, the sintering furnace is heated in order to create suitable production temperatures in the different process zones (I-VII) having different temperatures, said zones including a drying zone (I), a heating zone (II), a sintering zone (III), an equalizing zone (IV), a first cooling zone (V), a second cooling zone (VI) and a third cooling zone (VII). During start-up, the cooling gas to be conducted to the second cooling zone (VI) is heated by means of a heating device (3) up to a temperature that is higher than the ambient temperature.

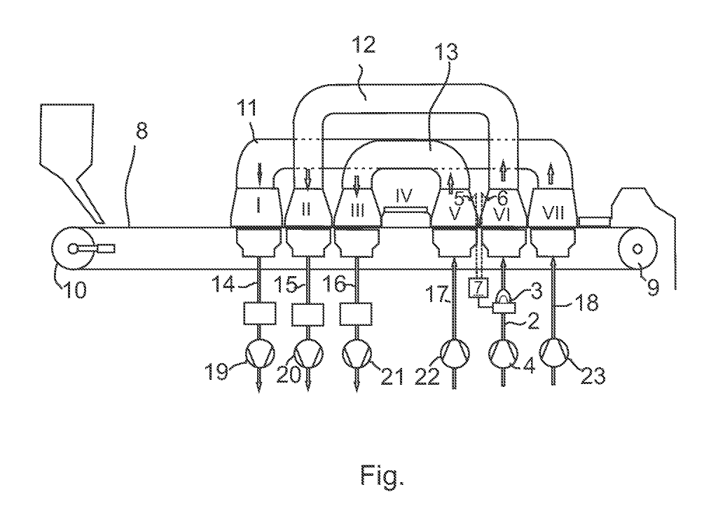

### FIELD OF INVENTION

The invention relates to a method defined in the preamble of claim 1. The invention further relates to an equipment defined in the preamble of claim 8.

### BACKGROUND OF INVENTION

When restarting a sintering furnace after cooling (during start-up), the second cooling zone warms up slower than the first cooling zone. Likewise, the heating zone warms up slower than the sintering zone.

The problem is that the time consumed in the start-up of a cooled furnace becomes rather long, because the temperature differences between said zones increase as the temperatures climb higher.

### OBJECT OF INVENTION

The object of the invention is to eliminate the above mentioned drawbacks.

A particular object of the invention is to introduce a method and sintering furnace, by means of which the time consumed in the start-up of a sintering furnace could be shortened, so that energy could be saved and the heat-up process could be facilitated.

### SUMMARY OF INVENTION

The method according to the invention is characterized by what is set forth in the appended claim 1.

According to the invention, the cooling gas to be conducted to the second cooling zone during start-up is heated up to a temperature that is higher than the ambient temperature.

According to the invention, the equipment includes a heating device that is arranged in the inlet gas duct feeding cooling gas to the second cooling zone, said heating device being arranged, during the start-up of the sintering furnace, to heat the cooling gas to be conducted to the second cooling zone up to a temperature that is higher than the ambient temperature.

In an embodiment of the method, the cooling gas to be conducted to the second cooling zone is during start-up heated up to a temperature of roughly 90° C.

In an embodiment of the method, the temperatures of the first cooling zone and the second cooling zone are measured; on the basis of the measured temperatures, the temperature difference between the first and second cooling zone is calculated; and on the basis of the obtained temperature difference, the power of heating the cooling gas to be fed in the second cooling zone is adjusted.

In an embodiment of the method, the temperature of the second cooling zone is measured, the obtained temperature of the second cooling zone is compared with a predetermined threshold value, and the heating of the cooling gas fed in the second cooling zone is stopped, when the temperature of the second cooling zone surpasses said threshold value.

In an embodiment of the method, the cooling gas to be conducted to the second cooling zone is heated up by burning fuel by a burner arranged in the inlet gas duct, in the flowing direction in succession to the blower.

In an embodiment of the method, the heating capacity of the cooling gas to be conducted to the second cooling zone is adjusted by adjusting the power of the burner.

In an embodiment of the method, the cooling gas is air.

In an embodiment of the equipment, the heating device is during start-up arranged to heat the cooling gas to be conducted to the second cooling zone up to a temperature of roughly 90° C.

In an embodiment of the equipment, the equipment includes a blower that is arranged in the inlet gas duct for creating a cooling gas flow, and a burner that is arranged in the inlet gas duct for burning fuel in the inlet gas duct, said burner comprising said heating device.

In an embodiment of the equipment, there is provided a first temperature measurement device for measuring the temperature of the first cooling zone.

In an embodiment of the equipment, there is provided a second temperature measurement device for measuring the temperature of the second cooling zone.

In an embodiment of the equipment, the equipment includes a control device for adjusting the power of the heating device.

In an embodiment of the equipment, the control device is arranged to adjust the power of the heating device on the basis of the measurement result obtained from the first temperature measurement device and/or from the second temperature measurement device.

In an embodiment of the equipment, the equipment includes a conveyor belt that is arranged as an endless loop around a deflector roll and a driven roll, in order to transfer the material bed through the process zones of the sintering furnace. The conveyor belt is made permeable to gas. Further, the equipment includes circulation gas ducts provided above the conveyor belt for conducting gas from the cooling zones to the drying, heating and sintering zones, on top of the material bed. Moreover, the equipment includes exhaust gas ducts placed below the conveyor belt for conducting gas that is exhausted from the drying, heating and sintering zones and has been passed through the material bed and the conveyor belt. Further, the equipment includes inlet gas ducts placed below the conveyor belt for conducting gas to the cooling zone. In addition, the equipment includes blowers that are arranged in the exhaust gas ducts and the inlet gas ducts for creating a gas flow.

### LIST OF DRAWINGS

The invention is explained in more detail below by means of various embodiments and with reference to the appended drawing, which is a schematical illustration of an embodiment of a strand sintering equipment according to the invention.

### DETAILED DESCRIPTION OF INVENTION

The drawing illustrates a strand sintering equipment for continuously sintering mineral material, such as ferrochromium, that is pelletized and/or in some other granular form.

The equipment includes a strand sintering furnace 1, which is divided into a number of successive process zones, each of which has different temperature conditions while the sintering furnace is in operation.

The zones include a drying zone I, where the temperature after start-up is roughly 500° C., and where the fresh material is dried, i.e. dehydrated; a drying zone II, where the dried material is heated and the temperature of the material bed is raised up to roughly 1,150° C.; a sintering zone III, where the temperature is roughly 1,350° C., and the material is sintered; as well as an equalizing zone IV. After the equalizing zone IV, there are provided three successive cooling zones V, VI, VI, where the sintered material bed is gradually cooled, so that when coming out of the furnace, its temperature is roughly 400° C.

The conveyor belt 8, which conveys the material bed through said zones, is a perforated steel band, where the perforation allows the gas to flow through. The invention is also feasible in connection with a sintering furnace of the so-called moving grate type.

The sintering furnace is operated so that the fresh material is fed at the first (in the drawing left-hand side) end of the furnace, on top of a steel band 8 to form a bed with a thickness of several tens of centimeters. The conveyor belt 1 proceeds as an endless loop around a deflector roll 9 and a driven roll 10. Above the conveyor belt 8, there are provided three overhead circulation gas ducts 11, 12, 13, which conduct gas from the cooling zones V, VI, VII to the heating, drying and sintering zones I, II, III, on top of the material bed. Both of the circulation gas ducts 12 and 13 are provided with a burner (not illustrated) for heating the gas. The lower exhaust gas ducts 14, 15, 16, which are placed below the conveyor belt 1, boosted by the blowers 19, 20, 21, conduct the gas led through the material bed and the conveyor belt 8 away from the drying, heating, and sintering zones I, II, III. The lower inlet gas ducts 17, 2, 18 conduct gas from underneath the conveyor belt 1 to the cooling zones V, VI and VII. Respectively, the movement of the gas in the inlet gas ducts 17, 2 and 18, is created by blowers 22, 4 and 23.

In the inlet gas duct 2, which leads cooling gas to the second cooling zone VI, there is arranged a heating device 3, which is for example a burner burning fuel in the gas duct. Its purpose is during start-up to heat the cooling gas to be conducted to the second cooling zone VI up to a temperature that is higher than the ambient temperature. Generally the cooling gas is air, which is absorbed from the atmosphere. The heating device 3 is used for raising the temperature of the cooling air from the outside air temperature 20° C. for example up to 90° C. If the quantity of the cooling air to be blown in is for example 20,000 Nm³/h in the start-up of the second cooling zone VI, the power of the heating device 3 should be roughly 500 kW.

The power of the heating device 3 can be adjusted by a control device 7. The temperature of the first cooling zone V is measured by a first temperature measurement device 5, and the temperature of the second cooling zone VI is measured by a second temperature measurement device 6. The control device 7 is arranged to adjust the power of the heating device 3 on the basis of the measurement result obtained from the first temperature measurement device 5 and/or from the second temperature measurement device 6.

For example, the temperatures of the first cooling zone V and of the second cooling zone VI are measured, and the temperature difference between the first and second cooling zone is calculated. On the basis of the obtained temperature difference, the power of heating the cooling gas to be fed in the second cooling zone VI is adjusted.

In order to prevent an excessive rise in the temperature of the perforated steel band used as the conveyor belt, the temperature of the second cooling zone VI is measured, said measured temperature of the second cooling zone is compared with a predetermined upper threshold value, and the heating of the cooling gas to be conducted to the second cooling zone is stopped, when the temperature of the second cooling zone VI surpasses said upper threshold value.

The invention is not restricted to the above described embodiments only, but many modifications are possible within the scope of the inventive idea defined in the appended claims.

1. A method for starting up a sintering furnace (1), in which method the sintering furnace is heated in order to create suitable production temperatures in the different process zones (I-VII) having different temperatures, said zones including a drying zone (I), a heating zone (II), a sintering zone (III), an equalizing zone (IV), a first cooling zone (V), a second cooling zone (VI) and a third cooling zone (VII), characterized in that during start-up, the cooling gas to be conducted to the second cooling zone (VI) is heated up to a temperature that is higher than the ambient temperature.

2. A method according to claim 1, characterized in that the cooling gas to be conducted to the second cooling zone (VI) is during start-up heated up to a temperature of roughly 90° C.

3. A method according to claim 1, characterized in that
the temperatures of the first cooling zone (V) and the second cooling zone (VI) are measured,
on the basis of the measured temperatures, the temperature difference between the first and second cooling zones is calculated,
on the basis of the obtained temperature difference, the power of heating the cooling gas to be fed in the second cooling zone (VI) is adjusted.

4. A method according to claim 1, characterized in that the temperature of the second cooling zone (VI) is measured, the obtained temperature of the second cooling zone is compared with a predetermined threshold value, and the heating of the cooling gas fed in the second cooling zone (VI) is stopped, when the temperature of the second cooling zone (VI) surpasses said threshold value.

5. A method according to claim 1, characterized in that the cooling gas to be conducted to the second cooling zone (VI) is heated up by burning fuel by a burner (3) arranged in the inlet gas channel (2), in the flowing direction in succession to the blower (4).

6. A method according to claim 5, characterized in that the power of heating the cooling gas to be conducted to the second cooling zone (VI) is adjusted by adjusting the power of the burner (3).

7. A method according to claim 1, characterized in that the cooling gas is air.

8. A sintering equipment for continuously sintering mineral material, said equipment including a sintering furnace (1), which is divided into a number of successive process zones with different temperature conditions, said zones including a drying zone (I) for drying fresh material, a heating zone (II) for heating the dried material, a sintering zone (III) for sintering the material, an equalizing zone (IV) for equalizing the temperature of the material,
a first cooling zone (V), a second cooling zone (IV) and a third cooling zone (V) for gradually cooling the sintered material, said equipment also including an inlet gas duct (2) for conducting the cooling gas to the second cooling zone (VI), characterized in that the equipment includes a heating device (3), which is arranged in said inlet gas duct (2) and adjusted, during the start-up of the sintering furnace, to heat the cooling gas to be conducted to the second cooling zone (VI) up to a temperature that is higher than the ambient temperature.

9. Equipment according to claim 8, characterized in that the heating device (3) is during start-up arranged to heat the cooling gas to be conducted to the second cooling zone (VI) up to a temperature of roughly 90° C.

10. Equipment according to claim 8, characterized in that said equipment includes:
a blower (4), which is arranged in the inlet gas duct (2) for creating a cooling gas flow, and
a burner (3) that is arranged in the inlet gas duct for burning fuel in the inlet gas duct, said burner comprising said heating device.

11. Equipment according to claim 8, characterized by a first temperature measurement device (5) for measuring the temperature of the first cooling zone (V).

12. Equipment according to claim 8, characterized by a second temperature measurement device (6) for measuring the temperature of the second cooling zone (VI).

13. Equipment according to claim 8, characterized in that the equipment includes a control device (7) for adjusting the power of the heating device (3).

14. Equipment according to claim 13, characterized in that the control device (7) is arranged to adjust the power of the heating device (3) on the basis of the measurement result obtained from the first temperature measurement device (5) and/or from the second temperature measurement device (6).

15. Equipment according to claim 8, characterized in that the equipment includes
a conveyor belt (8), which is lead as an endless loop around a deflector roll (9) and a driven roll (10) for transferring the material bed through the process zones (I-VII) of the sintering furnace, said conveyor belt being made permeable to gas,
circulation gas ducts (11, 12, 13), provided above the conveyor belt (8) for conducting gas from the cooling zones (V, VI, VII) to the drying, heating and sintering zones (I, II, III), on top of the material bed,
exhaust gas ducts (14, 15, 16), placed below the conveyor belt (8) for conducting gas that is exhausted from the drying, heating and sintering zones (I, II, III) and has been passed through the material bed and the conveyor belt,
inlet gas ducts (17, 2, 18), placed below the conveyor belt for conducting gas to the cooling zone (V, VI, VII), and
blowers (19, 20, 21, 22, 2, 23), that are arranged in the exhaust gas ducts (14, 15, 16) and the inlet gas ducts (17, 2, 18) for creating a gas flow.
